(19) United States
(12) Patent Application Publication
(10) Pub. No.: US 2025/0261798 A1
(43) Pub. Date: Aug. 21, 2025

(54) DEVICE AND METHOD FOR THE GRINDING OF GRINDING MATERIAL

(71) Applicant: Jura Elektroapparate AG, Niederbuchsiten (CH)

(72) Inventors: Philipp Büttiker, Oberbuchsiten (CH); Shahryar Reyhanloo, Immensee (CH)

(73) Assignee: Jura Elektroapparate AG, Niederbuchsiten (CH)

(21) Appl. No.: 18/565,128

(22) PCT Filed: May 24, 2022
(86) PCT No.: PCT/EP2022/064065

§ 371 Date: May 20, 2024

(30) Foreign Application Priority Data
Jun. 1, 2021 (EP) 21177220.7

(51) Int. Cl. A47J 42/46; A23F 5/08; A47J 31/42; A47J 42/06; A47J 42/08; A47J 42/10

(52) U.S. Cl. CPC A47J 42/46; A23F 5/08; A47J 31/42; A47J 42/06; A47J 42/08; A47J 42/10

(57) ABSTRACT

A device and method are described for the grinding of grinding material by at least one grinder, the method comprising: actuating the grinder in a first direction for grinding of the grinding material, and actuating the grinder in a second direction different from the first direction, wherein the grinder is actuated in the second direction after completion of the grinding of the grinding material.

### FIELD OF THE INVENTION

The invention relates to a method for the grinding of grinding material by at least one grinder, wherein the method comprises actuating the grinder in a first direction to grind the grinding material and actuating the grinder in a second direction different from the first direction.

Grinders are known which have an adjustment device for setting or varying a degree of grinding, for example a coffee powder fineness. In particular, the adjustment device can be used to adjust the cutting or grinding tools of a grinder relative to one another. For example, a grinding gap or the height of a grinding gap between a grinding cone and a grinding ring can be adjusted. This adjustment can be made manually or automatically.

When adjusting the degree of grinding to finer degrees of grinding, i.e., when reducing the grinding gap, for example, there is the problem that, following the initial grinding of grinding material, residues of this grinding material and/or residues of the ground grinding material are located between the grinding tools, in particular in the grinding gap. These residues may hinder or prevent an adjustment to finer degrees of grinding and may cause damage to the grinder during an adjustment.

One way to counter this problem is to adjust the degree of grinding during the process of grinding the grinding material, for example shortly after the start of the grinding operation. However, the grinder to be adjusted may have a high grinding capacity or drawing capacity. In other words, shortly after the start of the grinding operation, a significant amount of grinding material may already have been ground. This approach therefore has the disadvantage that an adjustment during the grinding operation must be made very quickly after the start of the grinding operation, for example within a few seconds.

### BACKGROUND OF THE INVENTION

The object of the present invention is therefore that of providing a method which facilitates the adjustment of a grinder, in particular a method which enables the user of the grinder to carry out the adjustment of the grinder within a larger period of time.

In the case of the method of the type mentioned at the outset this object is achieved in particular in that the grinder is actuated in the second direction after completion of the grinding of the grinding material in response to a user input and/or automatically in response to a number of actuations of the grinder in the first direction.

### SUMMARY OF THE INVENTION

The actuation of the grinder in the first direction can, for example, be a first (rotational) movement of a first grinding element, e.g. a grinding cone, relative to a second grinding element, e.g. a grinding ring, for grinding material in a grinder. The second direction can, for example, be a (rotational) movement counter to the first direction. The first and/or the second direction can also be an axial movement of the first grinding element relative to the second grinding element. The actuation of the grinder in the second direction can, for example, be the enlargement of a grinding gap. By actuating the grinder in the second direction, a grinding material, ground grinding material or a mixture of grinding material and powder located in the grinding gap can be conveyed out of the grinding gap. In other words: actuating the grinder in the second direction relieves the grinder.

The degree of grinding can be adjusted, in particular reduced, by relieving the grinder after completion of the grinding cycle or a number of grinding cycles, i.e., the grinding of the grinding material, wherein residues of the grinding material are removed in advance from the grinding gap, i.e., from the cutting region between the first grinding element and the second grinding element. On the one hand, this makes it possible or easier to adjust the degree of grinding. On the other hand, the user of the grinder is able to adjust the grinder at any time after the completed grinding cycle or the number of grinding cycles and before a next grinding cycle. This considerably extends the time period in which the grinder can be adjusted.

In one embodiment, it is provided that the grinder is actuated in the second direction, preferably automatically, in response to the number of actuations, in particular each actuation, of the grinder in the first direction.

The number of actuations can be predetermined or determinable. In particular, the number of actuations may be adjustable, for example based on the amount (average, estimated or actual) of grinding material and/or ground grinding material accumulating in the grinding gap during a grinding operation. This allows the grinder to be relieved with a frequency sufficient to adjust the grinder between each of the grinding cycles or between a number of grinding cycles. For example, it can be provided that the grinder is relieved after each grinding operation. It may also be provided that the grinder is actuated in the second direction in response to a plurality of actuations of the grinder in the first direction. In this way, protection of the grinder and/or of the grinder drive can be achieved.

By regularly relieving the grinder or actuating the grinder in the second direction in response to a user input and/or in response to a number of actuations (e.g. every actuation) of the grinder in the first direction, a grinding gap between the grinding elements of the grinder can be regularly cleaned or freed, in particular from foreign particles such as grinding material residues. This can prevent the formation of a built-up edge.

Furthermore, a uniform load on the grinder, in particular the (plastics) housing of the grinder, can be achieved. This can prevent or reduce deformation of the grinder or the grinder housing. Displacement of the grinding elements or grinding rings relative to each other can also be prevented or reduced.

As a result, a constant grinding result can be achieved, in particular over the service life of the grinder.

In one embodiment, it is provided that the grinder is actuated in the second direction in response to the user input and/or in response to an obstruction to grinding detected during grinding, wherein the user input is directed, for example, toward cleaning and/or adjusting the grinder.

For example, each actuation of the grinder in the second direction may be preceded by the user input and/or the detected obstruction to grinding. In another embodiment, the grinder may additionally be actuated in the second direction in response to the user input and/or the detected obstruction, i.e., in addition to an actuation of the grinder in the second direction that occurs automatically after completion of the grinding of the grinding material or after one or more actuations of the grinder in the second direction. In other words, actuation of the grinder in the second direction can occur several times between two grinding operations.

The grinder can be actuated only, or also, in response to a user input and/or in response to an obstruction to grinding detected during grinding, for example in response to a user input that is directed toward adjusting the grinder. In this way, the grinder is always, and in particular only, relieved before a grinder adjustment takes place and/or grinding material and/or ground grinding material obstructs grinding. This further protects the grinder.

In addition, the actuation of the grinder in the second direction can facilitate cleaning of the grinder in response to a user input. Actuation of the grinder in the second direction can convey grinding material and/or ground grinding material out of the grinding gap, for example in the direction of the input point of the grinding material. In this way, the removal of the surplus grinding material or of grinding material and/or ground grinding material located in the grinding gap from the grinder, for example by means of a suction device, can be facilitated.

The actuation of the grinder in the second direction can depend on the type of user input. For example, the grinder can be actuated in the second direction for a first period of time in response to a user input aimed at adjusting the grinder. The grinder can be actuated in the second direction for a second period of time in response to a user input directed toward cleaning the grinder, wherein the second period of time is longer than the first period of time. For example, the first period of time is shorter than or equal to two seconds and/or the second period of time is longer than two seconds and shorter than or equal to ten seconds. Likewise, the grinder can be actuated in the second direction in response to an obstruction to grinding detected during grinding for the first or second time duration.

In one embodiment, it is provided that the actuation of the grinder comprises a movement, in particular a translational and/or rotational movement, of a first grinding element relative to a second grinding element. The first grinding element can be a grinding cone, the second grinding element a grinding ring, or vice versa. The movement of the first grinding element relative to the second grinding element serves to grind the grinding material or to relieve the grinder, depending on the direction of movement. The first direction can be a direction of rotation of the first grinding element relative to the second grinding element. The second direction can be a direction of rotation counter to the first-mentioned direction of rotation, i.e., a backward movement of the grinder. Likewise, the first direction can be a translational movement of the first grinding element toward the second grinding element. The second direction can be a direction of translation of the first grinding element away from the second grinding element, counter to the first-mentioned direction of translation.

In one embodiment, it is provided that the actuation of the grinder in the second direction comprises an adjustment of the grinder to set a second degree of grinding, which is preferably coarser than a previously set first degree of grinding. The second direction represents the direction of translation described above. In other words, the direction of translation may be a direction along an axis of rotation of the grinding element or one of the grinding elements, for example wherein a movement of the grinding element or one of the grinding elements in the direction of translation results in a change, for example an increase in a distance between the grinding elements, in particular the grinding gap.

In one embodiment, it is provided that the first grinding element is a grinding rotor, in particular a grinding cone, and the second grinding element is a grinding stator, in particular a grinding ring.

In one embodiment, it is provided that the method further comprises: adjusting the grinder, in particular following the actuation of the grinder in the second direction, to set a third degree of grinding, preferably finer than the first and/or second degree of grinding.

For example, the method comprises the grinding of grinding material with a first, medium degree of grinding. After completion of the grinding cycle, the degree of grinding can be changed to a second, coarser degree of grinding, which is coarser than the medium degree of grinding, in order to relieve the grinder or to remove grinding material remaining in the grinding gap. A third, fine degree of grinding, which is finer than the medium degree of grinding, can then be set to produce ground coffee with the fine degree of grinding. By actuating the grinder in the second direction after, in particular directly after, the grinding of the grinding material has been completed, a user of the grinder is able to set the third degree of grinding at any time before a next grinding cycle.

In one embodiment, it is provided that the adjustment of the grinder comprises enlarging and/or reducing a grinding gap, in particular a grinding gap between the first grinding element and the second grinding element.

In one embodiment, it is provided that the adjustment of the grinder comprises a translational movement and/or axial movement of one or the first grinding element relative to one or the second grinding element.

In one embodiment, it is provided that the method further comprises: actuating the grinder in the first direction to grind the grinding material with a degree of grinding, in particular the first and/or the third degree of grinding.

In one embodiment, it is provided that the grinding material comprises coffee beans and/or coffee powder and/or the grinder is a grinder for a coffee machine.

In one embodiment, it is provided that the grinder is set up to convey grinding material from an input side to an output side with operation in the first direction and/or that the grinder is set up to convey grinding material back to an input side with operation in the second direction.

The input side can be designed to receive grinding material or to convey grinding material to the grinder. For example, the input side is adjacent to or comprises a container into which a user can place grinding material, i.e., which can hold grinding material. The output side can be designed to receive and/or convey ground coffee, in particular for further use, for example within a coffee machine. The grinding gap can represent a boundary or a transition between the input side and the output side.

On the one hand, when the grinder is actuated in the first direction, grinding material is conveyed in the direction of the grinding gap for grinding of the grinding material. This increases the efficiency of the grinding operation. On the other hand, when the grinder is operated in the second direction, grinding material or ground grinding material is conveyed out of the grinding gap. This serves to relieve and ultimately to protect the grinder and/or to facilitate cleaning of the grinder.

In a further, possibly independent embodiment, a coffee machine is provided, having a grinder and means for carrying out one of the methods described above.

The invention is described in greater detail below with reference to several preferred exemplary embodiments.

### BRIEF DESCRIPTION OF THE DRAWINGS

The figures show:

FIG. 1 a flow diagram of a first method for the grinding of grinding material,

FIG. 2 a flow diagram of a second method for the grinding of grinding material,

FIG. 3A a first grinding element of a grinder in a 3-dimensional view,

FIG. 3B a second grinding element of a grinder in a 3-dimensional view,

FIG. 4A a first grinder in a 3-dimensional view,

FIG. 4B the first grinder in a sectional view, and

FIG. 5 a second grinder in a sectional view.

### DETAILED DESCRIPTION

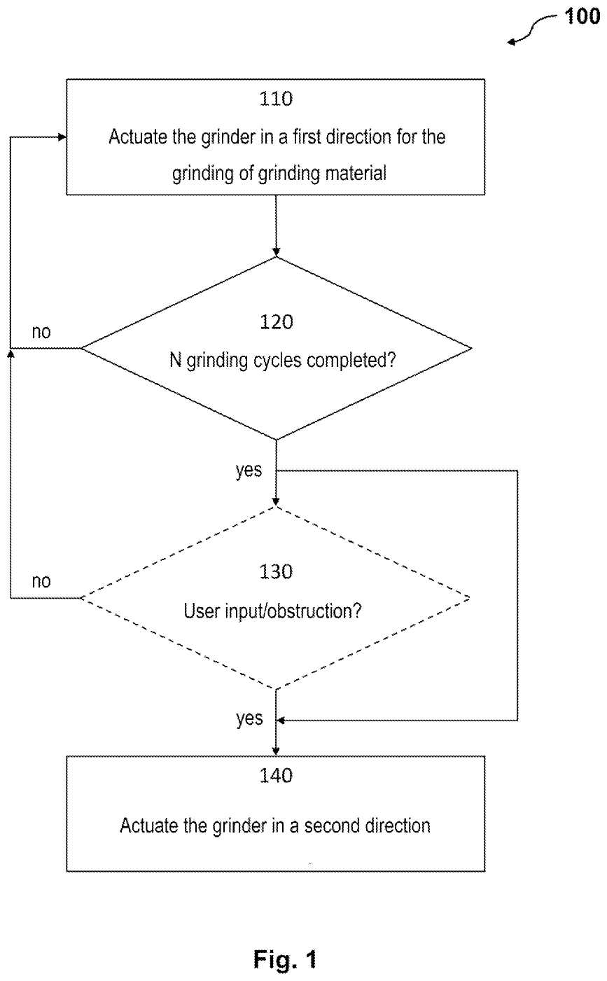

FIG. 1 shows a flow diagram of a first method 100 for the grinding of grinding material by at least one grinder. The method 100 comprises a first step 110 for actuating the grinder in a first direction. When the grinder is actuated in the first direction, grinding material is ground. For example, within the grinder, a first grinding element is actuated relative to a second grinding element in a first direction. The first direction can, for example, represent a direction of rotation or a direction of translation of the first grinding element relative to the second grinding element, which enables the grinding of grinding material.

The method 100 may comprise, in step 120, determining whether the grinding of grinding material, i.e., the previous grinding cycle, has been completed. Step 120 may further comprise determining whether a number N, in particular a plurality, of grinding cycles have been completed, wherein N is greater than or equal to 1 or 2. In other words: step 120 may comprise determining whether the grinder has been actuated N times in the first direction to grind the grinding material, in particular has been actuated N times for a predetermined period of time.

If fewer than N grinding cycles have been completed or the grinder has been operated less than N times in the first direction for the grinding of grinding material, the method returns to step 110.

If it has been determined in step 120 that the grinding cycle or the number N of grinding cycles has been completed, the grinder is actuated in a second direction, which is different from the first direction, in step 140. By actuating the grinder in the second direction, the grinder is relieved. The grinder can be actuated in the second direction directly following step 110 or step 120, i.e. directly after completion of the one or more N grinding operations. The determination of the completion of N grinding cycles in step 120 may be implicit in step 110. For example, one or more grinding operations may be considered completed when one or more actuations of the grinder in the first direction have occurred over a (pre) determined period of time, in particular in each case.

Additionally or alternatively, the actuation of the grinder in the second direction may occur in response, in particular only in response, to a user input that is detected or received in step 130. The user input is directed, for example, toward adjusting the grinder. For example, the grinder is only or always actuated in the second direction when a user input is received. The user input can, for example, be received after completion of one or N grinding cycles. Alternatively or additionally, the user input can be received at any time, i.e. independently of the completion of one or more grinding cycles or the actuation of the grinder in the first direction. In a further example, the grinder is only actuated in the second direction if a user input is received that is directed toward adjusting the grinder, in particular toward refining the degree of grinding, for example toward reducing the grinding gap. If no user input is received, the method returns to step 110.

Additionally or alternatively, the actuation of the grinder in the second direction may be in response, in particular only in response, to a detection of an obstruction of the grinder. For example, step 130 may comprise determining whether a previous grinding cycle was completed as intended and/or whether irregularities occurred during one of the previous grinding cycles, in particular whether an obstruction of the grinding cycle or the grinding elements occurred, for example an increased expenditure of force was determined during the grinding cycle or increased resistance was determined during the grinding cycle. If no such obstruction is determined, the method returns to step 110. The method 100 may comprise neither, one or both of method steps 120 and 130.

Similarly, actuation of the grinder in the second direction in response to the user input/obstruction may be preceded by determining that there has not (yet) been actuation of the grinder in the second direction between the actuation or last actuation of the grinder in the first direction and the user input/obstruction. In other words: the method 100 comprises actuating the grinder in the second direction in response to a user input/obstruction if actuation of the grinder in the second direction has not (yet) occurred after completion of the previous grinding of grinding material.

The method 100 can be carried out for the grinding of grinding material by a plurality of grinders separately for each of the plurality of grinders or for all of the plurality of grinders together, in particular simultaneously.

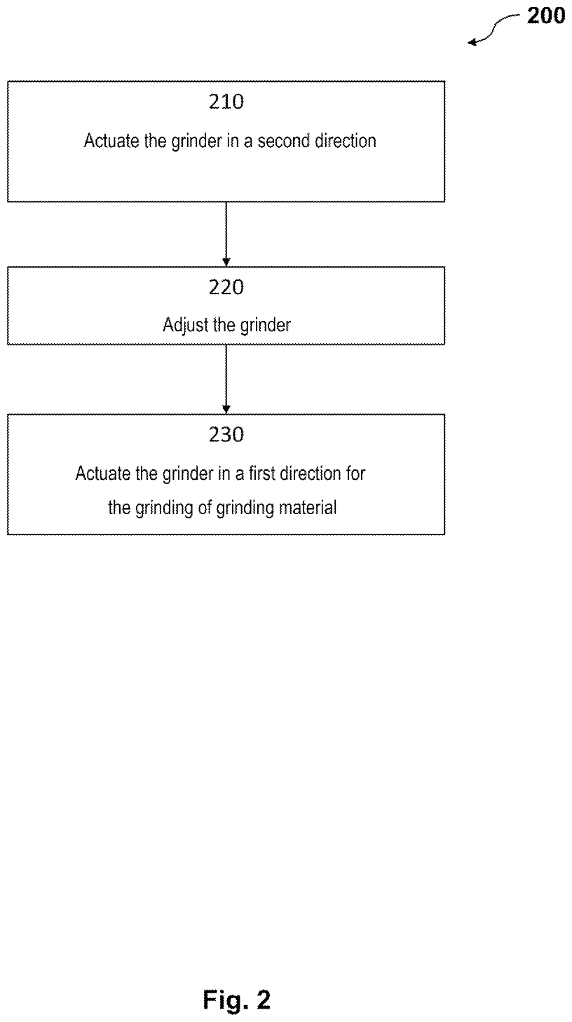

FIG. 2 shows a flow diagram of a second method 200 for the grinding of grinding material with at least one grinder. The method 200 begins with a method step 210, in which the grinder is actuated in a second direction. The method step 210 may correspond to the method step 120 of the method 100 from FIG. 1. The second direction in method 200 may be the second direction from method 100. In other words: the method steps 220 and 230 may follow the method 100.

Following the actuation of the grinder in the second direction, in particular to relieve the grinder, the grinder is adjusted in step 220. In particular, step 220 may comprise adjusting the grinder toward a finer degree of grinding. For example, step 220 comprises reducing a distance between two grinding elements of the grinder, in particular reducing a grinding gap or a height of a grinding gap between the two grinding elements.

Following the adjustment of the grinder in step 220, in step 230 the grinder is actuated in a first direction for the grinding of grinding material. The first direction in step 230 may correspond to the first direction in step 110 of the method 100. In other words: in step 230, the grinder is actuated in the first direction for the grinding of grinding material with an adjusted, for example finer, degree of grinding, in particular compared to the grinding of grinding material in step 110 of the method 100 from FIG. 1.

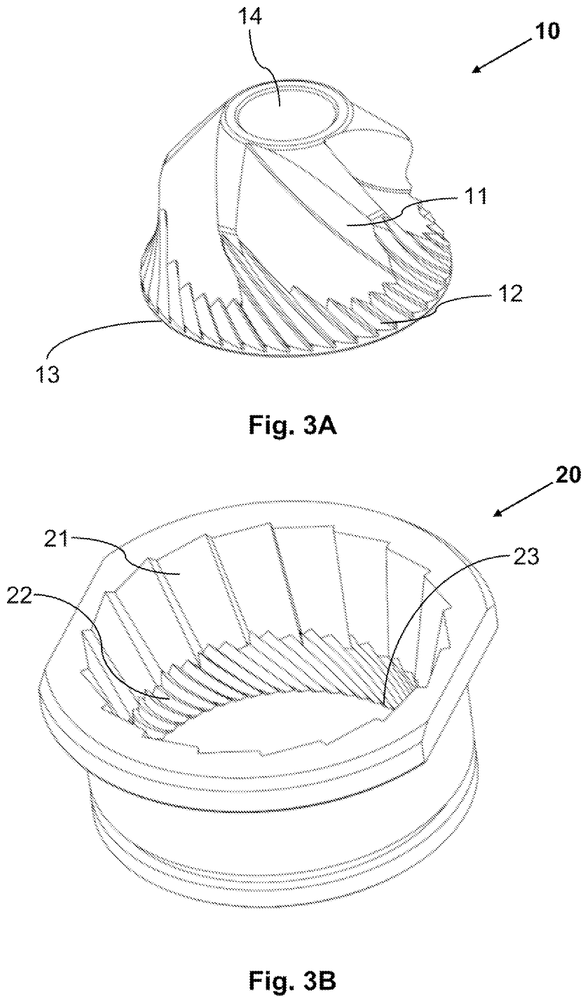

FIG. 3A shows a first grinding element 10 of a grinder in a 3-dimensional view. The first grinding element 10 is a circular grinding cone 10 or truncated grinding cone. The grinding cone 10 comprises first guide means 11 and second guide means 12 arranged periodically along its circular circumference. The first and second guide means 11 and 12 are designed to convey grinding material and/or ground grinding material towards a circular cutting edge 13 of the grinding cone 10 or to move it away from the cutting edge 13. The second guide means 12 are arranged axially and radially between the first guide means 11 and the cutting edge 13. The second guide means 12 are arranged at a higher periodicity than the first guide means 11 on a circumference of the grinder 10. The grinding cone 10 comprises a centrally arranged opening 14, i.e., surrounding the center axis of the grinding cone, which extends along the center axis through the grinding cone 10. The opening 14 is a receptacle for a rotation shaft or a rotation shaft element and/or an adjustment device.

FIG. 3B shows a second grinding element 20 of a grinder in a 3-dimensional view. The second grinding element 20 is a circular grinding ring 20. Similarly to the grinding cone 10 described above, the grinding ring 20 comprises first guide means 21 and second guide means 22 arranged periodically along its circular circumference. The first and second guide means 21 and 22 are designed to convey grinding material and/or ground grinding material toward a circular cutting edge 23 of the grinding ring 20 or to move it away from the cutting edge 23. The second guide means 22 are arranged axially and radially between the first guide means 21 and the cutting edge 23. The second guide means 22 are arranged at a higher periodicity than the first guide means 21 on a circumference of the grinding ring 20.

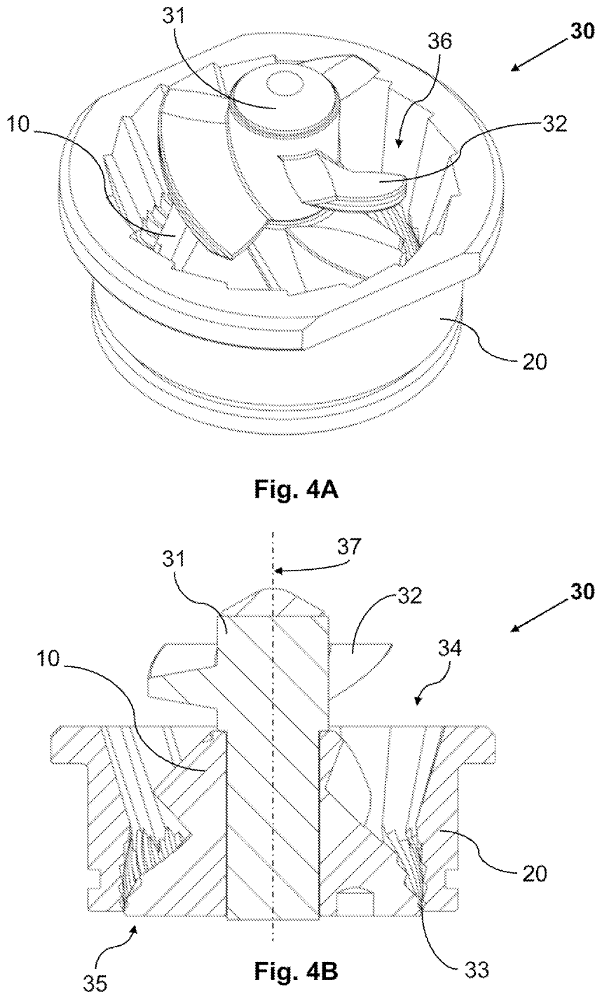

FIG. 4A shows a first grinder 30 comprising the first grinding element 10 and the second grinding element 20 in a 3-dimensional view. The grinder 30 comprises a shaft element 31. The shaft element 31 is arranged in the opening 14 of the grinding cone 10. The grinding cone 10 is rotatably mounted on the shaft element 31 or connected to the shaft element 31. The grinding cone 10 is movable relative to the grinding ring 20 and/or relative to the shaft element 31, in particular rotatable. The shaft element 31 can be connected to the grinding cone 10 and can also be movable relative to the grinding ring 20, in particular rotatable. The shaft element 31 can be a rotation shaft and/or an adjustment device.

The grinder 30 comprises third guide means 32 for conveying grinding material toward a grinding gap 33. The third guide means 32 are arranged periodically around a center axis of the shaft element 31 on a circular circumference of the shaft element 31. The third guide means 32 are arranged on the shaft element 31 with a lower periodicity than the first and second guide means on the grinding cone 10 and on the grinding ring 20, respectively.

FIG. 4B shows the first grinder 30 in a sectional view. Like or similar features are provided with like reference signs. As illustrated in FIG. 4B, the grinder 30 comprises an input side 34 and an output side 35. The input side 34 is designed to receive grinding material, which can be conveyed toward the grinding gap 33 and in the direction of the output side 35 by means of the first, second and/or third guide means. After the grinding of the grinding material by the cutting edges 13 and 23 in the grinding gap 33, the ground grinding material reaches the output side 35 of the grinder 30.

The grinder 30, in particular the grinding cone 10 and the grinding ring 20, are not designed to be rotationally symmetrical or rotationally invariant. A direction of rotation of the grinding cone 10 relative to the grinding ring 20, or vice versa, is therefore already recognizable on the grinding cone 10 and/or on the grinding ring 20. The grinder 30 is designed by means of the first, second and/or third guide means to convey grinding material within a grinding chamber 36 from the input side 34 to the output side 35, or from the input side 34 to the grinding gap 33, in a first direction of rotation of the grinding cone 10 relative to the grinding ring 20. In the example shown, the first direction of rotation is a right-hand rotation, i.e., a clockwise rotation, of the grinding cone 10 relative to the grinding ring 20. The grinding chamber 36 is enclosed or delimited by the grinding cone 10 and the grinding ring 20.

The grinder 30 is further designed to convey grinding material within the grinding chamber 36 from the output side 35 in the direction of the input side 34, or from the grinding gap 33 in the direction of the input side 35, with a second direction of rotation of the grinding cone 10 relative to the grinding ring 20. In the example shown, the second direction of rotation is a left-hand rotation, i.e., an anti-clockwise rotation, of the grinding cone 10 relative to the grinding ring 20.

The shaft element 31 can also comprise an adjustment device. The adjustment device can be used to adjust or set the grinding cone 10 and/or the grinding ring 20, in particular a relative distance between the grinding cone 10 and the grinding ring 20. For example, the grinding cone 10 can be moved along a center axis 37 of the grinder 30 relative to the grinding ring 20, in particular by moving the shaft element 31 along the center axis 37 of the grinder 30. By axially adjusting the grinding cone 10 relative to the grinding ring 20 along the center axis 37, the height or size of the grinding gap 33 can be changed or set. In other words, the relative distance between the cutting edges 13 and 23 of the grinding cone 10 and the grinding ring 20, respectively, can be adjusted or set by an axial arrangement of the grinding cone 10 relative to the grinding ring 20 along the center axis 37.

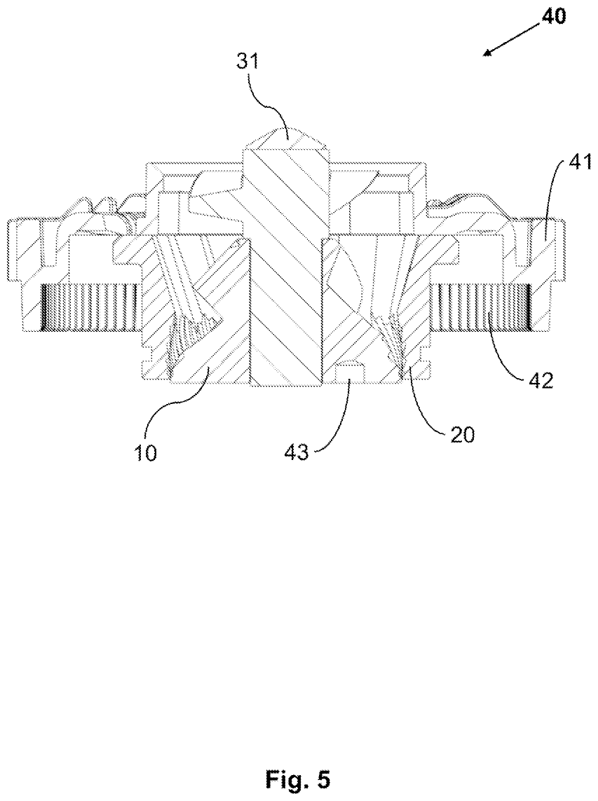

FIG. 5 shows a second grinder 40 in a sectional view. Similarly to the first grinder 30, the second grinder 40 comprises the grinding cone 10, the grinding ring 20 and the shaft element 31. Like or similar features are provided with like reference signs.

The grinder 40 further comprises a drive unit 41 which is designed to move the grinding ring 20 relative to the grinding cone 10, or vice versa, in one or the first or one or the second direction. For this purpose, engagement means 42 are provided on the drive unit 41, which are designed to drive a rotation of the grinding ring 20 relative to the grinding cone 10 and relative to the shaft element 31, for example by means of corresponding engagement means (not shown) on the grinding ring 20. In order to ensure a relative rotation of the grinding ring 20 in relation to the grinding cone 10, the grinding cone 10 comprises a locking means 43, in the example shown a recess 43 for receiving a locking pin (not shown).

1. A method for the grinding of grinding material by at least one grinder, the method comprising:
actuating the grinder in a first direction for grinding of the grinding material; and
actuating the grinder in a second direction different from the first direction;
characterized in that the grinder is actuated in the second direction after completion of the grinding of the grinding material in response to a user input and/or automatically in response to a number of actuations of the grinder in the first direction.

2. The method as claimed in claim 1, characterized in that the grinder is actuated in the second direction, preferably automatically, in response to each actuation of the grinder in the first direction.

3. The method as claimed in claim 1, characterized in that the grinder is actuated in the second direction in response to an obstruction to grinding detected during grinding.

4. The method as claimed in claim 3, characterized in that the user input is directed toward cleaning and/or adjusting the grinder.

5. The method as claimed in claim 1, characterized in that the actuation of the grinder comprises a movement, in particular a translational and/or rotational movement, of a first grinding element relative to a second grinding element.

6. The method as claimed in claim 1, characterized in that the actuation of the grinder in the first direction comprises a rotational movement in the first direction of the first grinding element relative to the second grinding element, and wherein the actuation of the grinder in the second direction comprises a rotational movement in the second direction, counter to the first, of the first grinding element relative to the second grinding element.

7. The method as claimed in claim 1, characterized in that the actuation of the grinder in the second direction comprises an adjustment of the grinder to set a second degree of grinding, which is preferably coarser than a previously set first degree of grinding.

8. The method as claimed in claim 5, characterized in that the first grinding element is a grinding rotor, in particular a grinding cone, and wherein the second grinding element is a grinding stator, in particular a grinding ring.

9. The method as claimed in claim 1, characterized in that the method further comprises:
adjusting the grinder, in particular following the actuation of the grinder in the second direction, to set a third degree of grinding, preferably finer than the first and/or second degree of grinding.

10. The method as claimed in claim 1, characterized in that the adjustment of the grinder comprises enlarging and/or reducing a grinding gap, in particular a grinding gap between the first grinding element and the second grinding element.

11. The method as claimed in claim 1, characterized in that the adjustment of the grinder comprises a translational movement and/or axial movement of one or the first grinding element relative to one or the second grinding element.

12. The method as claimed in claim 1, characterized in that the method further comprises:
actuating the grinder in the first direction for grinding of the grinding material with a degree of grinding, in particular the first and/or the third degree of grinding.

13. The method as claimed in claim 1, characterized in that the grinding material comprises coffee beans and/or coffee powder and/or the grinder is a grinder for a coffee machine.

14. The method as claimed in claim 1, characterized in that the grinder is set up to convey grinding material from an input side to an output side with operation in the first direction, and/or in that the grinder is set up to convey grinding material back to an input side with operation in the second direction.

15. A coffee machine as claimed in claim 1 having at least one grinder and a data processing device comprising means for carrying out the method.
